(19) United States
(12) Patent Application Publication
(10) Pub. No.: US 2017/0008330 A1
(43) Pub. Date: Jan. 12, 2017

(54) MARKER

(71) Applicant: BEAUTY UNION GLOBAL LIMITED, Hong Kong (CN)

(72) Inventors: Yi Ming HUI, GUANGDONG (CN); Zhi WANG, GUANGDONG (CN); Carmit TORDJMAN, LONDON GREATER LONDON (GB)

(21) Appl. No.: 15/113,307

(22) PCT Filed: Jan. 22, 2015
(86) PCT No.: PCT/IB2015/050485

§ 371 Date: Jul. 21, 2016

Related U.S. Application Data
(60) Provisional application No. 61/929,996, filed on Jan. 22, 2014.

(30) Foreign Application Priority Data
May 15, 2014 (CN) 201420249896.2

(51) Int. Cl. B43K 8/03; B43K 8/06; B43K 11/00; B43K 8/02

(52) U.S. Cl. CPC B43K 8/03; B43K 8/026; B43K 8/06; B43K 11/005

(57) ABSTRACT

A marker comprising: a body comprising a marker fluid absorber, a marker fluid reservoir, and a flow pipe fluidly coupling the reservoir to the absorber, and a marking core extending from the absorber to outside the body.

### FIELD OF THE INVENTION

The invention relates to writing utensils such as markers, having parts therein for improving passage, storage and/or distribution of marker-fluid.

### BACKGROUND

Markers such as pens, paint brushes, printers and the like are used to leave recordable traces upon surfaces. Typically, the recordable traces are left by the application of a marker-fluid, such as paint, an ink or the like onto the surface.

Traditional chalk for blackboards is messy and white board pens have gradually replaced the chalk. However, when ink is used in the markers, there are often problems with the flow of the ink Such problems may be expressed by uneven flow of ink or leaks from the marker. Moreover, when the marker (often rapidly) runs out of ink the whole marker has to be discarded.

In regard to the commercially available white board pens that can be refilled, usually a rubber pouch, a pipe and a piece of felt are provided inside a pen casing. In use, a top part of the pen casing is first taken off, then the pen tip is immersed into ink, next it is pressed to force the air in the pipe out, then release it, so as to draw the ink into the pipe, and via the pipe; the ink is spilled on the absorbent felt for storage. In this way, albeit it has solved the problem that a pen can not be reused, the process of drawing ink into the pen can not be accurately controlled. After ink being drawn to the pen, the ink remaining in the pipe could leak onto the writing board through the pen tip, which would cause inconvenience to use the pen, or even render the pen unusable. In addition, during the process of taking the pipe out to draw ink and then remounting the pipe back into the pen, it may contaminate a user's hands, which also causes inconvenience in using the pen. Moreover, due to the poor sealing effect, the ink inside a pen is prone to volatilize, and thus causing a waste. Furthermore, a user is not able to check level of the ink remaining in the pen easily.

There is a need for improving the storage, flow and distribution of ink in the marking-fluid cartridges such as markers. Embodiments disclosed herein address this need.

### BRIEF DESCRIPTION OF THE FIGURES

For a better understanding of the invention and to show how it may be carried into effect, reference will now be made, purely by way of example, to the accompanying drawings.

With specific reference now to the drawings in detail, it is stressed that the particulars shown are by way of example and for purposes of illustrative discussion of the preferred embodiments of the present invention only, and are presented in the cause of providing what is believed to be the most useful and readily understood description of the principles and conceptual aspects of the invention. In this regard, no attempt is made to show structural details of the invention in more detail than is necessary for a fundamental understanding of the invention; the description taken with the drawings making apparent to those skilled in the art how the several forms of the invention may be embodied in practice.

In the accompanying drawings:

FIG. 1a depicts in cross section and exploded view one marker pen embodiment that has an ink reservoir and a flow pipe connected to the reservoir. The flow pipe is design to permit even distribution and flow of the ink within and to without the marker;

FIG. 1b shows a vertical cross-section of one suitable flow pipe;

FIG. 1c shows a vertical cross-section of another suitable flow pipe;

FIG. 1d shows a vertical cross-section yet another suitable flow pipe;

FIG. 1e illustrates in cross section a refill mechanism in the marker shown in FIG. 1a, at rest position;

FIG. 1f shows the same mechanism at refill position;

FIG. 2a illustrates in exploded perspective view another marker pen embodiment having venting tubes extending into an ink reservoir;

FIG. 2b shows in exploded perspective view parts of the marker embodiment depicted in FIG. 2a;

FIG. 2c shows in perspective view the ink reservoir in shown in FIG. 2a;

FIG. 2d shows in perspective view an venting tube holder in the ink reservoir shown in FIG. 2c;

FIG. 2e present a cross-sectional view of the second marker pen embodiment, and

FIG. 3 shows another marker pen embodiment.

### SUMMARY OF THE INVENTION

According to one aspect of the invention, a marker is provided, comprising:
a body comprising a marker fluid absorber, a marker fluid reservoir, and a flow pipe fluidly coupling the reservoir to the absorber, and
a marking core extending from the absorber to outside the body.

According to another aspect a marker is provided comprising:
a body comprising a marker fluid absorber, a marker fluid reservoir, venting tubes extending from the absorber to the reservoir, and
a marking core extending from the absorber to outside the body.

The marker may further comprise:
tube-holders between the absorber and the reservoir, the tube-holders with holes extending therethrough from the reservoir to the absorber, and venting tubes hanging in the reservoir from holes of the tube holders.

According to another aspect, a marker is provided comprising:
a body comprising a marker fluid absorber, a marker fluid reservoir fluidly connected to the absorber, and a refill mechanism fluidly connected to the reservoir;
and
a marking core extending from the absorber to outside the body.

In some embodiments there is a groove between the marking core and the body allowing passage of air between the body and outside the body.

The marker may further comprise a flow pipe fluidly coupling the reservoir to the absorber.

The flow pipe may comprise a plurality of holes along the pipe.

The markers may further comprise a refill mechanism allowing refill of the fluid reservoir, wherein the refill mechanism comprises a blotter configured to allow leak-less and clean refilling of the marker via the refill mechanism.

The blotter may comprise ink-absorbent material.

The holes may be arranged around the pipe; optionally the holes are evenly arranged around the pipe, so that whichever position the marker is held during use, ink can flow out of the flow-pipe into the absorber.

The holes may be arranged in rows along the pipe.

Each row may have holes of varying sizes.

The spacing between the holes may vary in each row.

Preferably the holes proximal to the reservoir are smaller than the holes distal to the reservoir.

In some embodiments an inner diameter of the pipe is between 0.5 and 5 mm, preferably between 1 and 3 mm The smaller holes may be 0.5-1.5 mm diameter, and the larger holes 1-2 mm diameter.

The spacing may gradually decrease from around 10 mm between the holes most proximal to the reservoir to around 5 mm between the holes most distal to the reservoir.

According to another aspect, a kit is provided comprising a marker and an ink refiller comprising a refill stem, wherein the stem and the refill mechanism are configured to allow tight engagement therebetween.

In some embodiments the marker further comprises a gap between the pen core and a top part of the body, via which exhaust gas can escape out of the marker during refilling of the marker.

According to yet another aspect, a refill container comprising a reservoir and a refill mechanism is provided, the mechanism comprising: an endcap and an elastomeric crown, wherein:
the crown comprises an essentially flat seal with multiple fingers mounted thereon;
the fingers press against an interior roof of the endcap to allow holding the seal against a bottom opening of the endcap when the container is not filled;
the crown allows the flat seal part to rise towards the interior roof and ink to flow around the seal and in between the fingers and subsequently into the reservoir when the container is refilled.

The container may be one of the markers indicated above.

The marker may further comprise an air buffer chamber in the body, the chamber connected to the groove.

In some embodiments there is a gap between the venting tubes and the absorber.

### DESCRIPTION OF THE PREFERRED EMBODIMENTS

Embodiments described herein are directed towards providing an improved marker or other marking utensil that can be filled with marker-fluid, such as pens, ink-jet cartridges, toner cartridges and the like, a selection of which are described in the embodiments below, for illustrative purposes only.

The marking utensils are characterized as having improved storage and/or uniform flow of marker fluid out of the utensil due to a reservoir and/or tubes/pipes in an absorber and/or in a marker fluid reservoir, as will be further explained below. They have an excellent tightness; and their ink has limited volatility.

One embodiment is a marker comprising:
a body;
within the body: a marker fluid absorber, at least one flow pipe and a marker fluid reservoir;
a marking core extending from within the absorber to without the body;
wherein:
the flow pipe extends from the reservoir to within the absorber and fluidly couples the reservoir to the absorber;
the flow pipe comprises a plurality of holes along the pipe.

The pipe allows the ink to smoothly permeate the absorber.

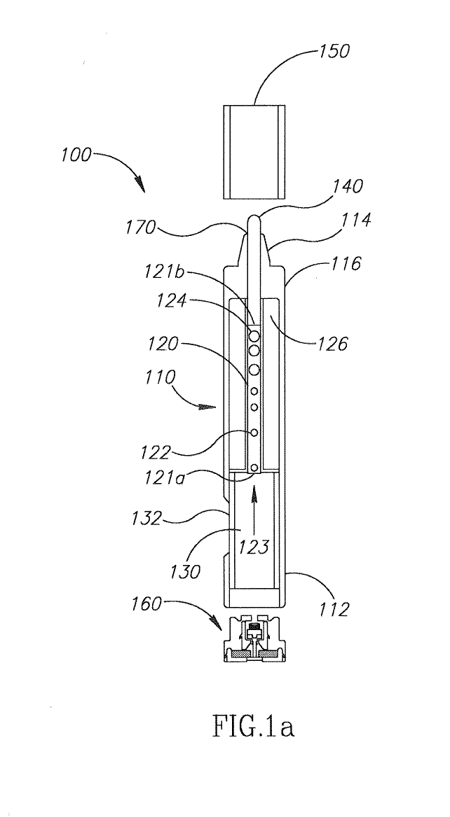

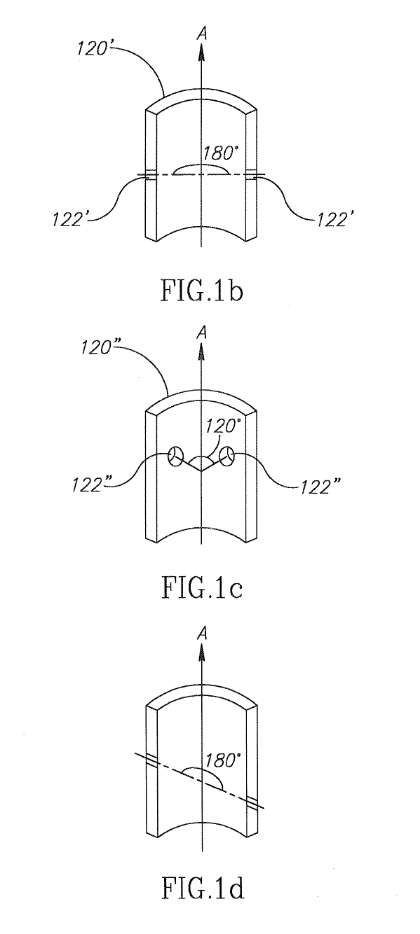

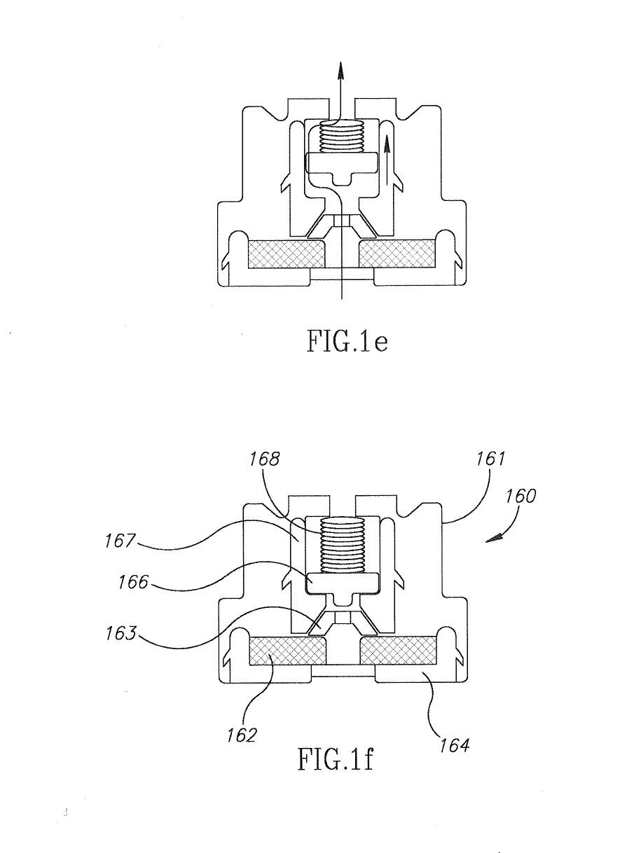

Reference is now made to FIG. 1 a showing the marker embodiment 100 having a body 110 and a pen core (writing head) 140. The body 110 has a bottom part 112 and a top part 114.

The marker 100 has several special features that include a flow-pipe 120 with holes 122 and 124, and a reservoir 130.

The flow-pipe 120 is embedded in an absorber 126, which comprises ink-absorbent material. The flow-pipe 120 is hollow therein and is preferably open at the bottom end 121a and closed at the top end 121b. There are at least two holes in the flow-pipe 120, preferably evenly arranged around the flow-pipe 120, so that whichever position the marker is held during use, ink can flow out of the flow-pipe into the absorber 126. FIG. 1b, 1c show cross sections of flow pipe 120′, 120″, respectively, halved along their length, with examples of such arrangements, with holes 122′, 122″ respectively: in pipe 120″ the angle between the holes 122″ is about 120° relative to the centre of the pipe 120″. FIG. 1d shows in perspective view a half of another pipe embodiment, with holes 122″′ and 124″′, which are of different sizes as will be further explained below. Again, the holes 122″′ and 124″′, although at different locations along the length of the pipe 120″′, the angle between them is about 180° relative to the centre of the pipe 120″.

Preferably, the flow-pipe 120 comprises at least two rows of holes 122 and 124, again preferably evenly distributed as described above. FIG. 1 shows one row 123. In some preferred embodiments the holes along each row 123 have varying sizes and the spacing between them varies. In some preferred embodiments the holes 122 proximal to the bottom end 121 a are smaller than the holes 124 proximal to the top end 121b. The inner diameter of the pipe is preferably 0.5-5 mm, more preferable between 1 and 3 mm. The smaller holes 122 are preferably 0.5-1.5 mm, and the larger holes 124) are 1-2 mm. The spacing may gradually decrease from around 10 mm (±5 mm) between the hole 122 closest to the bottom end 121a and the hole 122 second closest thereto, to around 5 mm (±4 mm) between the two top holes 124. The dimensions may be selected according to various factors that influence the flow of the ink and its distribution in the absorber 126, for example the viscosity of the selected ink, and a synergistic effect of the flow-tube's inner diameter and length, the sizes of the holes and their spacing.

The flow-pipe 120 is fed ink by the reservoir 130 which is situated at the bottom end 112 of the body 110. The reservoir 130 may have an inverted nipple (not shown) extending from its roof thereinto, for example, into which the bottom part 121 a of the flow-pipe 120 may be tightly inserted.

When the marker 100 is positioned upright as it may be positioned when at rest, the ink cannot enter the flow-pipe 120 and thus this position may help conserve ink At this position, ink may further be conserved by putting a tightly fitting cap 150 onto the top part 114 of the body 110. Furthermore, the body 110 has a transparent window 132 comprising part of the reservoir 130, which allows a user to see the level of the ink in the reservoir 130 (most easily when the marker 100 is upright) and allows the marker to be refilled in a timely manner

In other embodiments (not shown) the body is mounted on the reservoir such that the entire reservoir is visible, and the walls of the reservoir are transparent.

Referring now to FIG. 1e, an example refill mechanism 160 is shown in expanded view. The refill mechanism 160 is installed into the reservoir 130.

The mechanism 160 comprises a piston 166 and resilient means, a spring 168. At rest position of the mechanism, as in Figure le, the piston 166 is urged down by the spring 168 to help prevent leakage of ink out of the marker 100. As shown in FIG. 1f, when the window 132 shows that the marker 100 requires refilling, an ink refiller (not shown) may be used to refill the reservoir 130 via the mechanism 160. For example the ink refiller may comprise a dispensing mechanism that includes a stem (not shown); to refill the stem is pushed against the piston 166 to move it up, thus allowing ink to enter the reservoir as shown.

According to one aspect, a kit is provided that comprises the ink refiller and the marker 100 or a plurality of refillers and markers 100, for example each refiller may contain ink having a particular colour. The stem of the ink refiller and the refill mechanism 160 may be sized and shaped to allow the stem to tightly fit each other to help minimize leaks of the marker fluid.

The example mechanism 160 shown in FIG. 1a further includes a refill cap 161, which fits snugly within the reservoir 130 as shown in FIG. 1a. The T-shaped piston 168 (having the large width slightly smaller than the inner diameter of the first end-cap 167 and the small width slightly smaller than the hole at the bottom of the first end-cap 167) and then the spring 168 is put into a first end cap 167 which is subsequently engaged with the refill cap 161. A sealing means 163 such as an O-ring is placed under the first end-cap 167, to reduce leak of ink during ink refill. A hole in the centre of the O-ring may be sized to snugly accommodate the narrow part of the T in the piston 168 to make a good seal. The hole and the narrow part may both be frusto-conical to allow a good sealing then the filling mechanism is at rest. A second end cap, containing a blotter 162, is then engaged with the refill cap 161, to complete the refill mechanism 160. The blotter 162 is preferably made of ink-absorbent material such as sponge and is shaped, sized and positioned to help further prevent leakage of ink during refilling and to help keep the refill piston 168 clean. In some embodiments the blotter is placed on top of the sealing means, so the filling stem contacts the sealing means. In some embodiments the mechanism 160 is configured to allow replacing the blotter, in other embodiments the same blotter can be used for multiple fillings, as the ink essentially evaporates between fillings and thus is dry before another filling.

Other refill mechanisms are known, the point is that these embodiments should preferably include the blotter similarly situated, to help minimize messy dripping of ink and keep the refill mechanism free of ink during refilling of the marker.

In some embodiments (not shown) the marker further comprises a protective cap that fits onto the bottom of the marker and covers the refill mechanism. Such cap may protect against inadvertent leakage of the marker or damage to the refill mechanism when the marker is not being refilled, and may be removed when refilling the marker.

During the time when no filling is needed, a liquid filling channel on said sealing ring 163 will be sealed, so as to ensure that the ink in said reservoir 130 does not flow backward. During the filling process, a filling pipe of an ink bottle may be inserted into the liquid filling channel on said sealing ring 163, and optionally further into the reservoir 130. Next, the ink is drawn to the reservoir 130, and then the ink in the reservoir 130 enters the pipe 120 and finally flows into the absorber 126 via the holes 122, 124. In this way, the core 140 remains constantly wet and thus provides for a smooth writing. After filling, the filling pipe is pulled out and the sealing ring 163 automatically closes.

Referring back to FIG. 1a, in some embodiments there is a gap between the pen core 140 and the top part 114 of the body 110, via which exhaust gas can escape out of the marker 100 during ink refilling.

Depending upon the properties of the fluid and the dimensions of the marker (the various parts therein), some shaking of the marker may be beneficial to help loosen bubbles in the marker and convect marker fluid therein, to help improve distribution and flow of the fluid within the marker.

In general, according to the invention the fluid reservoir may have various sizes, in some embodiments the reservoir occupies a rather larger portion of the space inside the marker than in the marker shown in FIG. 1a and the absorbers are shorter. Such markers require less frequent refilling due to the larger reservoir. However, while there is less of a need for a solution for evenly distributing the marker fluid in the absorber, the larger refills might entail accumulation of more air inside the absorber, which might interfere with the flow and the distribution of the marker fluid.

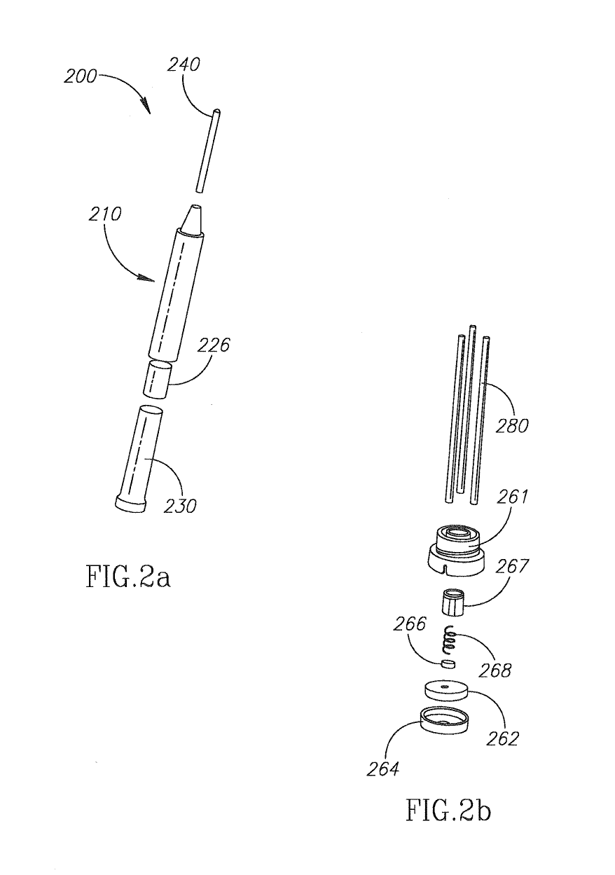

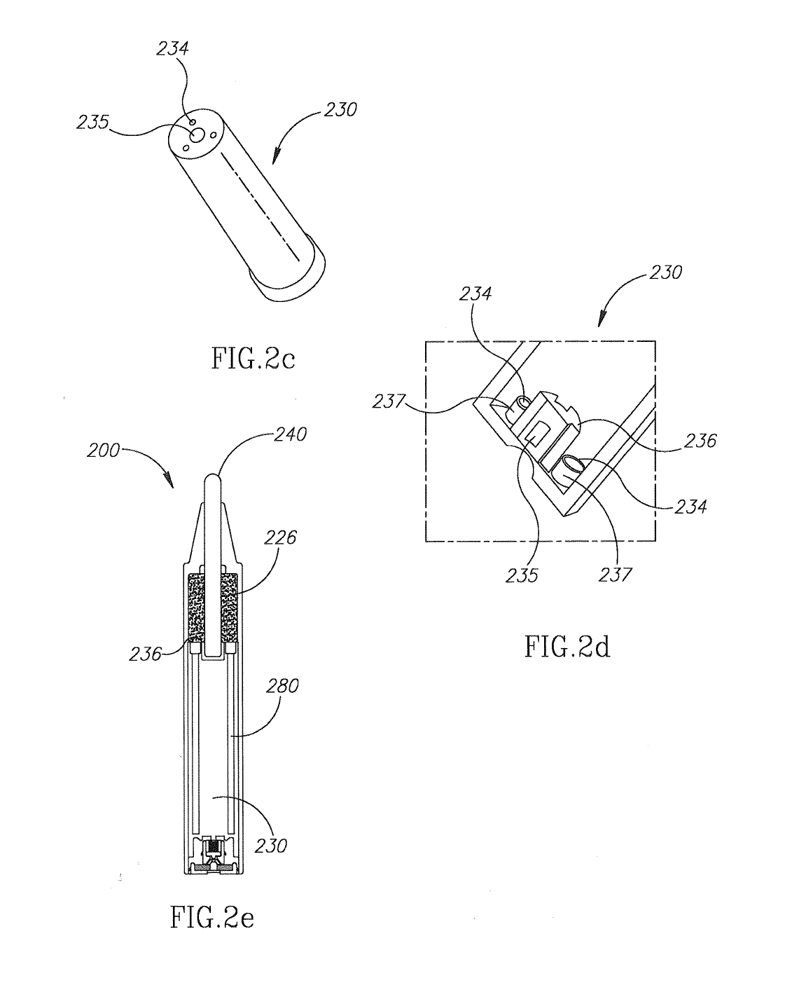

Therefore, as shown in FIGS. 2a-2e, another marker embodiment 200 is provided, which includes venting-tubes 280 in the reservoir 230. The role of the tubes is to transfer air trapped in the absorber 226 to the reservoir 230 when using the marker 200, such as writing with it on a board or filling the core 240/absorber 226 with ink, and to increase the speed of transfer of ink from the reservoir 230 to the absorber 226. The tubes 280 allow balancing the pressure between inside the absorber 226 and inside the reservoir 230, allowing the liquid and air to flow through smoothly. Note that as shown in FIG. 2e, the tubes 280 are not connected directly to the absorber 226; there is preferably a small gap 281 between the absorber 226 and the venting tubes 280.

The description below further clarifies the structure and how the marker 200 may work.

Referring in particular to FIG. 2a, the marker 200 has a particularly long core 240, extending from outside the marker 200 to a core holder 236 in the reservoir 230, also shown in FIG. 2d. The core holder 236 has a hole 235 extending therethrough, through which the marker fluid can be conveyed from the reservoir 230 directly to the core 240. The core 240 typically absorbs some of the marker fluid and excess marker fluid is absorbed by the absorber 226.

As shown in FIG. 2b, the marker 200 comprises three tubes 280. The tubes 280 are snugly inserted into tube holders 237 that have holes 234 extending therethrough from the reservoir 230 to the absorber 226. The reader is further referred to FIGS. 2d and 2e, showing the positions of the holes 234, 235 in the reservoir 230. Note that the tubes 280 hang from the tube holders 237, allow air to freely go from the absorber 226 into the reservoir 230.

Air might be introduced into the absorber 226 when the marker is filled with marker fluid. Some of the air escapes out of the absorber when the marker 200 is held upside down, but additional air may remain in the absorber 226 when the marker 200 is being used, and this is why there are preferably a plurality of tubes 280 evenly surrounding the core holder 236, to allow the air to escape however the marker 200 is held.

As in the first described embodiment 100, the marker 200 includes a refill mechanism 260, including a refill cap 261, piston 266 and spring 268 in a first end cap 267 (with a hole going therethrough, not shown) which is engaged with the refill cap 261. A sealing means such as an O-ring (not shown) is placed under the first end-cap 267. A second end cap 264, containing a blotter 262, is engaged with the refill cap 261, to complete the refill mechanism 260. Again, the blotter 262 is preferably made of ink-absorbent material such as sponge and is configured to further prevent leakage of ink during refilling.

It will occur that some embodiments may comprise both the reservoir with the holders for the venting-tubes, and the flow pipe, wherein the core is shorter like in the first embodiment.

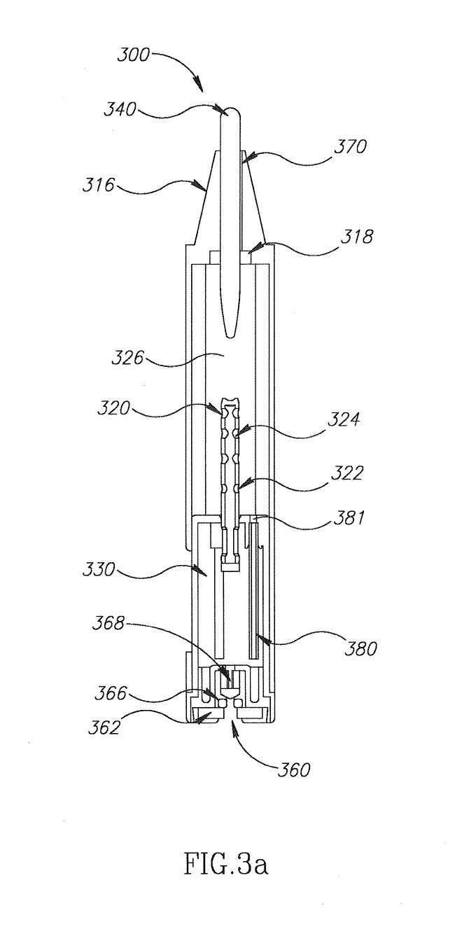

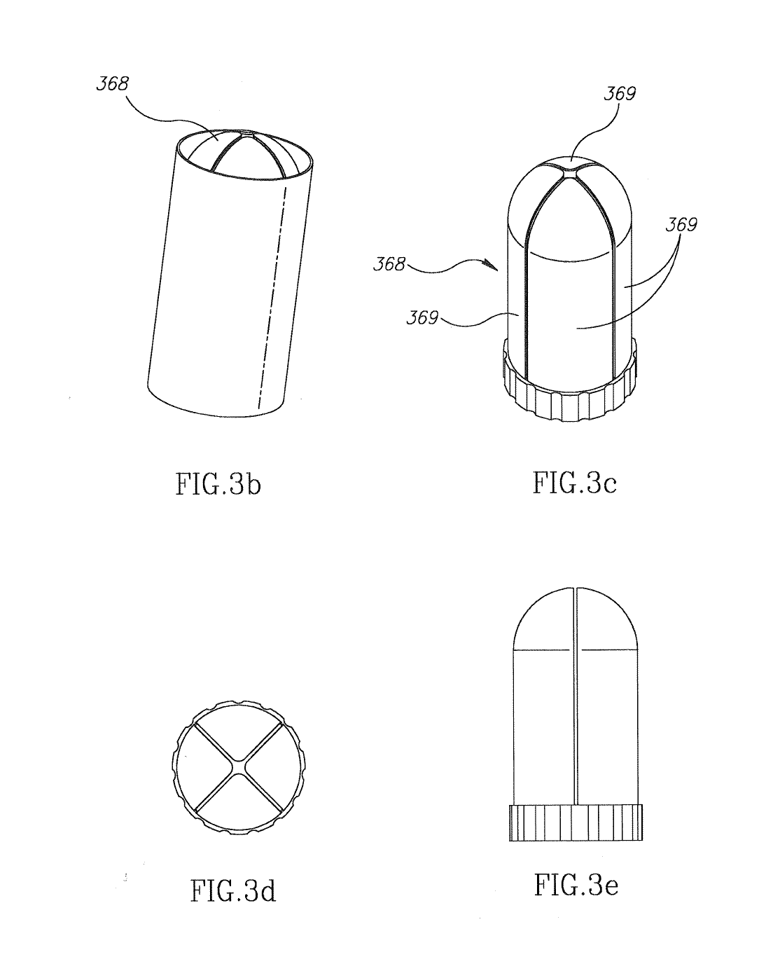

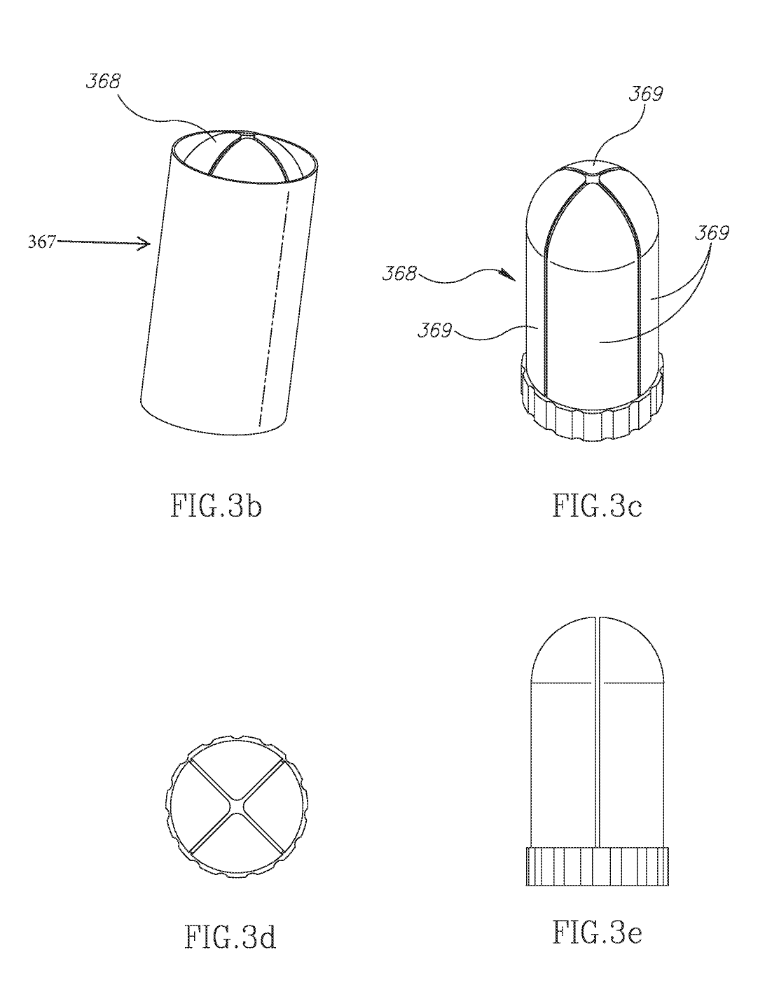

FIG. 3a shows yet another marker embodiment 300 that indeed has a shorter core 340, and comprises both the venting tubes 380 and the flow pipe 320, which again has larger holes 324 and smaller holes 322. As in the first embodiment 100, the marker 300 has a reservoir 330 and a groove 370 between the body 316 and the core 340 allowing passage of air (air may be forced out of the marker 300 while refilling and air may enter the marker 300 during writing). The marker 300 also comprises a refill mechanism 360. However the refill mechanism 360 does not include a spring but rather the resilient means 368 is a crown, shown in an end cap 367 in FIG. 3b, and alone in FIGS. 3c-3e: FIG. 3c is a perspective view, 3d a top view, 3e is a side view. The crown 368 is essentially a flat seal with multiple fingers 369 thereon. The fingers 369 are fairly flush with the interior roof of the endcap 367 to hold the flat seal part against the bottom opening of the endcap 367, to prevent escape of ink via the refill mechanism 360, when the marker 300 is not being filled. When the marker is filled the injection force is sufficient to push up the flat seal part and ink can flow around it, in between the fingers and subsequently into the reservoir 330.

The crown structure can be made of an elastomer such as a soft silicon rubber, which is preferably inert to the ink, since some inks contain substances such as chloride ions that aggravate conditions for corrosion.

The embodiment further comprises an air buffer chamber 318 connected to the groove 370, that allows air to enter the marker during writing and prevent creation of a sub-pressure inside the marker, while allowing excess air to escape during refills.

Note again that there is a small gap 381 between the absorber 326 and the venting tubes 380. The design is meant to keep the tubes floating, neither in direct connect with the bottom of the reservoir 330 nor with the upper part of the body 316 as well. The gap 381 helps allow equalization of pressure between the absorber 326 and the tubes 380.

It is stressed that some embodiments do not comprise a refill mechanism, in which case the reservoir may be sealed at its bottom. For example, in some embodiments, there are flow pipes and a similar reservoir, but no refilling mechanism.

The scope of the present invention is defined by the appended claims and includes both combinations and sub combinations of the various features described hereinabove as well as variations and modifications thereof.

In the claims, the word “comprise”, and variations thereof such as “comprises”, “comprising” and the like indicate that the components listed are included, but not generally to the exclusion of other components.

1-4. (canceled)

5. A marker comprising:
a body comprising a marker fluid absorber, a marker fluid reservoir fluidly connected to the absorber, and a refill mechanism fluidly connected to the reservoir; and
a marking core extending from the absorber to outside the body.

6. The marker of claim 5, wherein a groove is provided between the marking core and the body allowing passage of air between the body and outside the body.

7. The marker of claim 5, further comprising a flow pipe fluidly coupling the reservoir to the absorber.

8. The marker of claim 7, wherein the flow pipe comprises a plurality of holes along the pipe.

9. The marker of claim 5, wherein the refill mechanism comprises a blotter configured to allow leak-less and clean refilling of the marker via the refill mechanism.

10. The marker of claim 9, wherein the blotter comprises ink-absorbent material.

11. The marker of claim 8, wherein the holes are arranged around the pipe.

12. The marker of claim 11, wherein the holes are evenly arranged around the pipe, so that whichever position the marker is held during use, ink can flow out of the flow-pipe into the absorber.

13. The marker of claim 8, wherein the holes are arranged in rows along the pipe.

14. The marker of claim 13, wherein each row has holes of varying sizes.

15. The marker of claim 13, wherein the spacing between the holes varies in each row.

16. The marker of claim 14, wherein the holes proximal to the reservoir are smaller than the holes distal to the reservoir.

17. The marker of claim 8, wherein an inner diameter of the pipe is between 0.5 and 5 mm.

18. The marker of claim 17, wherein the inner diameter is between 1 and 3 mm.

19. The marker of claim 16, wherein the smaller holes each have a diameter of 0.5-1.5 mm, and the larger holes each have a diameter of 1-2 mm.

20. The marker of claim 15, wherein the spacing gradually decreases from around 10 mm between the holes most proximal to the reservoir to around 5 mm between the holes most distal to the reservoir.

21. A kit comprising the marker of claim 5 and an ink refiller comprising a refill stem, wherein the stem and the refill mechanism are configured to allow tight engagement therebetween.

22. The marker of claim 5, further comprising a gap between the pen core and a top part of the body, via which exhaust gas can escape out of the marker during refilling of the marker.

23. The marker of claim 5, wherein the refill mechanism comprises: an endcap and an elastomeric crown, wherein:
the crown comprises an essentially flat seal with multiple fingers mounted thereon,
wherein the fingers press against an interior roof of the endcap to allow holding the seal against a bottom opening of the endcap when the reservoir is not filled, and
wherein the crown allows the flat seal part to rise towards the interior roof and ink to flow around the seal and in between the fingers and subsequently into the reservoir when the marker is refilled.

24. (canceled)

25. The marker of claim 6, further comprising an air buffer chamber in the body, the chamber being connected to the groove.

26. (canceled)

27. The marker of claim 5, wherein the refill mechanism comprises a piston and a spring, wherein at rest, the piston is urged by the spring to prevent leakage of ink out of the marker and when the marker is refilled, the piston is pushed against the spring, thus allowing ink to enter the reservoir.
